(19) United States
(12) Patent Application Publication
(10) Pub. No.: US 2017/0032445 A1
(43) Pub. Date: Feb. 2, 2017

(54) PRODUCT CORRELATION BASED ON LOCATION

(71) Applicant: FLIGHT 001, INC., New York, NY (US)

(72) Inventor: John Sencion, New York, NY (US)

(73) Assignee: FLIGHT 001, INC., New York, NY (US)

(21) Appl. No.: 15/303,411

(22) PCT Filed: Apr. 10, 2015
(86) PCT No.: PCT/US15/25309

§ 371 Date: Oct. 11, 2016

Related U.S. Application Data
(60) Provisional application No. 61/978,563, filed on Apr. 11, 2014.

(51) Int. Cl. G06Q 30/06

(52) U.S. Cl. CPC G06Q 30/0631; G06Q 50/14

(57) ABSTRACT

Devices, systems and methods for providing a graphic depiction, such as a map, having product specific indicia to a traveler are described. The product specific indicia may be geographic location or zone specific. Moreover, the product specific indicia evidences a product, such as a plug adaptor, usable in a corresponding geographic zone. Each geographic zone may be partitioned on a country basis.

### RELATED APPLICATION DATA

The present disclosure claims priority to U.S. Provisional Patent Application No. 61/978,563, filed Apr. 11, 2014, which is incorporated herein by reference.

### FIELD

The present disclosure relates to data correlation and, more specifically, to visual depictions of underlying data correlation.

### BACKGROUND

People travel internationally on a daily basis, whether for business or pleasure. Governments of countries across the world have instituted procedures to accommodate these travelers in order to minimize hassle and stress experienced by travelers. For example, various countries have instituted global traveler programs that allow travelers enrolled in the programs to more easily bypass customs using fingerprint and retina scanning technologies rather than having to engage a customs official for an extensive interview each time the traveler crosses a border.

However, countries across the world, even those involved in global traveler programs, have failed to institute unifying and harmonizing features in relation to their infrastructures due to, for example, geographically local protocols and capabilities. For example, outlets used in countries differ on a country-by-country basis, without any rational divide (e.g., a continental divide). That is, countries within a single continent may use different power sources to charge electronic devices. Therefore, it can be difficult for a traveler to accurately determine, prior to embarking on their trip, which type of adaptor or plug may be needed in a specific geographic area to plug-in the traveler's electronic devices.

### SUMMARY

The present disclosure provides systems and methods for presenting a traveler with targeted data relating to the power source of respective countries, and also the types of power adaptors needed for use in specific countries. An aspect of the present disclosure relates to a method for providing a traveler with an adaptor based on travel considerations. The method includes indicating geographic zones on a graphic depiction. Each of the geographic zones are evidenced by a different indicia. The method further includes correlating adaptors to the different indicia. Each adaptor is correlated with an indicia correlated with a geographic zone that uses the adaptor. Moreover, the method includes selling the adaptors to travelers based on travel considerations, which include countries the travelers intend to visit.

The graphic depiction may be a map and the different indicia may abut on the map at borders of countries. Moreover, the indicia may be color coded. Additionally, the adaptors may be colored according to geographic zone indicia colors evidenced on the graphic depiction.

Another aspect of the present disclosure relates to a device for providing a traveler with an adaptor based on travel considerations. The device includes a memory having an adaptor database that contains plug adaptor information specific to geographic locations. Moreover, the device includes a processor that executes instructions stored within the memory to perform a set of actions. The processor generates a map having geographic zones, wherein each of the geographic zones are evidenced by a different indicia. The processor also receives an indication from a traveler evidencing trip information and correlates the received trip information with the geographic zones of the map. Moreover, the processor transmits a suggestion for a plug adaptor to the traveler. The suggested plug adaptor is correlative with indicia of the geographic zone relevant to the received trip information.

The indicia may be color-coded and the trip information may include more than one country that the traveler intends to visit. The more than one country may span more than one geographic zone. The more than one country may correlate with more than one indicia. The processor may suggest more than one plug adaptor to the traveler, with each of the more than one plug adaptor being correlated to a different geographic zone. Additionally, the processor may suggest a combo plug adaptor to the traveler. The combo plug adaptor may be usable in countries correlated to more than one indicia.

A further aspect of the present disclosure relates to a system for providing a traveler with a product based on travel considerations. The system includes a traveler computer in communication with a product computer. The product computer includes a processor and a memory that includes instructions operable to be executed by the processor to perform a set of actions. The processor generates a graphic depiction having geographic zones evidenced by indicia and receives an indication from the traveler computer evidencing trip information. Furthermore, the processor correlates the received trip information with the geographic zones of the graphic depiction and transmits a suggestion for a product to the traveler computer using the indicia of the geographic zone relevant to the received trip information.

The indication from the traveler computer that evidences trip information may involve the traveler computer interacting with the graphic depiction to select at least one geographic location relevant to a trip. The at least one geographic location relevant to the trip may include at least one country and each of the geographic zones of the graphic depiction may include multiple countries. Moreover, at least one of the geographic zones of the graphic depiction may include countries from at least two different continents. The product may be a plug adaptor. The suggestion transmitted to the traveler computer may include more than one product, with each of the products being correlated to a different geographic zone. Additionally, the suggestion may include a combo product usable in multiple geographic zones.

### BRIEF DESCRIPTION OF THE DRAWINGS

Specific embodiments of the present disclosure will become apparent and its construction and operation better understood, from the following detailed description when read in conjunction with the accompanying drawings, in which:

FIG. 1 is a graphic depiction having geographic zones according to the present disclosure;

FIG. 2 is an adaptor usable in at least one geographic zone according to the present disclosure;

FIG. 3 is an adaptor usable in at least one geographic zone according to the present disclosure;

FIG. 4 is an adaptor usable in at least one geographic zone according to the present disclosure;

FIG. 5 is an adaptor usable in at least one geographic zone according to the present disclosure;

FIG. 6 is a system for providing a traveler with a geographic zone specific product correlated to a graphic depiction containing geographic specific product indicia according to the present disclosure; and

FIG. 7 a method for providing a traveler with a geographic zone specific product correlated to a graphic depiction containing geographic specific product indicia according to the present disclosure.

### DETAILED DESCRIPTION

Detailed aspects of the present disclosure relating to devices, systems, and methods are disclosed herein. However, it is to be understood that the disclosed aspects are merely illustrative of the devices, systems, and methods, which may be embodied in various forms. Therefore, specific functional details disclosed herein are not to be interpreted as limiting, but merely as a basis for the claims and as a representative basis for enabling one skilled in the art to employ the present disclosure.

An aspect of the present disclosure relates to a map having geographic zones with indicia evidencing a type of product usable in a corresponding geographic zone. Each geographic zone may be partitioned on a country basis. However, one skilled in the art should appreciate geographic zones segmented according to other relevant areas such as continents, states, counties, and the like. The indicia may be, for example, shapes, text or letters, colors, patterns, or the like. For example, the indicia may evidence geographic zones having different types of outlet plugs. This correlation of indicia to geographic zones allows an individual, such as a traveler, to readily and accurately determine the type of adaptor or other product usable in a particular geographic location to plug-in the individual's electronic devices.

For further illustration, the adaptors or other products may be correlated to their relevant geographic zones using indicia similar or identical to that described herein. For example, the indicia used for a specific geographic zone may be implemented on a product usable within that geographic zone. Moreover, the indicia represented on the product may alternatively or simultaneously be in/on the product's packaging.

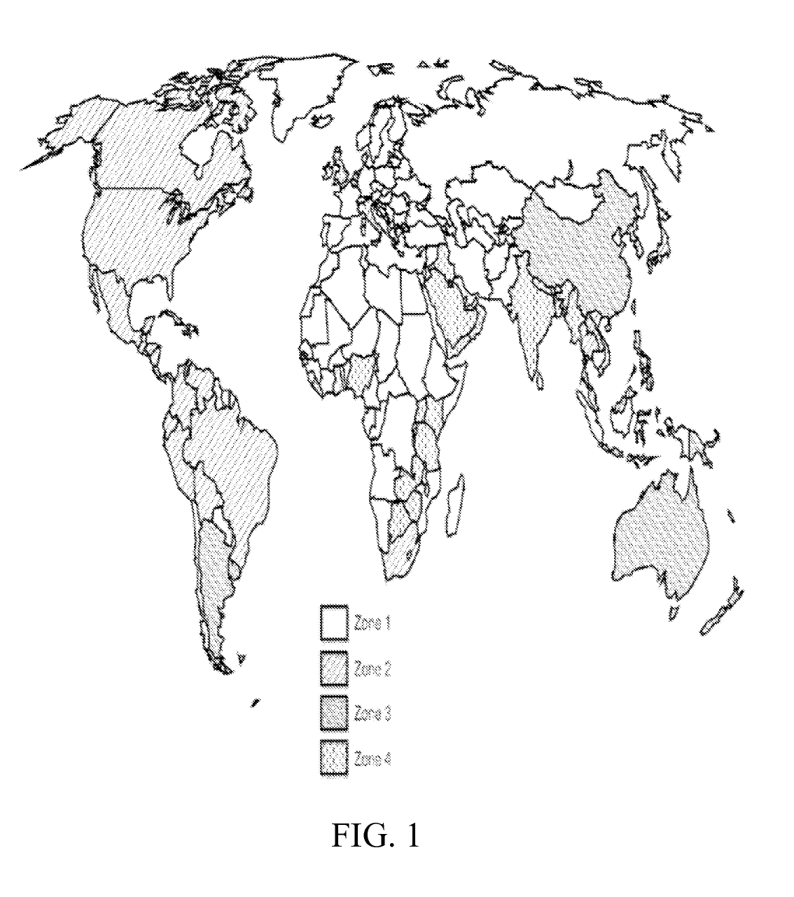

FIG. 1 illustrates a map having four zones according to the present disclosure. Each zone has a different indicia. In a non-limiting example, Zone 1 is white or has a clear pattern, Zone 2 has a diagonal stripe pattern angled downward from right to left, Zone 3 has a diagonal stripe pattern angled downward from left to right, and Zone 4 has a dashed line pattern. However, one skilled in the art should appreciate indicia having other characteristics/representations that allow an individual to easily ascertain the boundaries of various zones with the map. For example, the zones of the map may have color-coded or symbol coded indicia.

For example, each zone may identify a different type of adaptor or plug usable with a power outlet in that zone. However, one skilled in the art should appreciate that the zones may identify products other than adaptors or plugs that differ depending on geographic location without departing from the scope of the present disclosure.

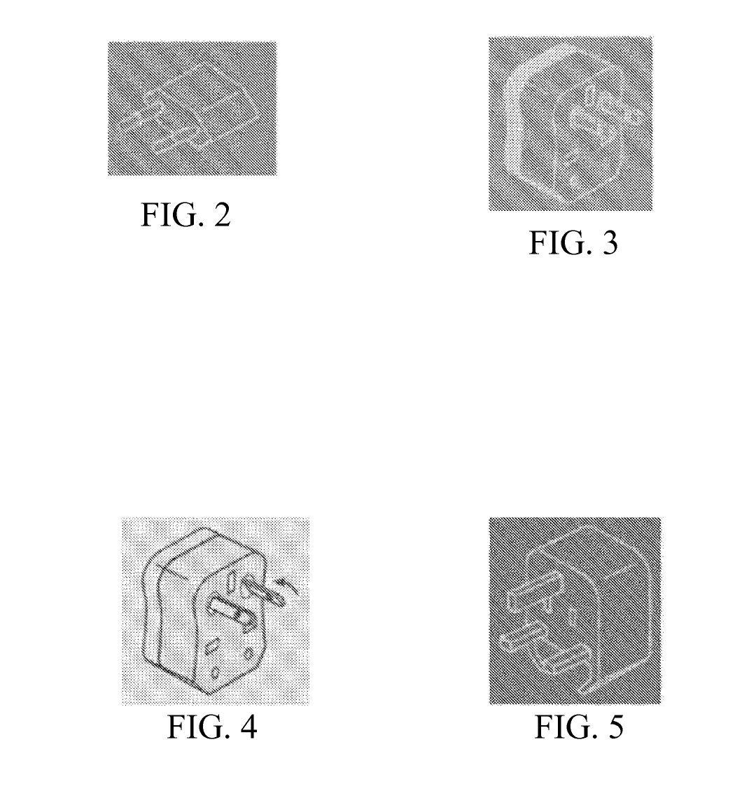

Zone 1 may relate to an adaptor similar to that illustrated in FIG. 2. The geographic locations that utilize an adaptor similar or identical to that of FIG. 2 include, without limitation, Europe (EU), Abu Dhabi, Afghanistan, Albania, Algeria, Andorra, Angola, Argentina, Armenia, Aruba, Austria, Azerbaijan, Azores, Balearic Islands, Bangladesh, Belgium, Belarus, Benin, Bhutan, Bolivia, Bonaire, Bosnia-Herzegovina, Brazil, Bulgaria, Burkina Faso, Burma, Burundi, Cambodia, Cameroon, Canary Islands, Cape Verde Islands, Central African Rep., Chad, Channel Islands, Chile, Comoros, Congo, Cote D'Ivore, Croatia, Cuba, Curacao, Czech Republic, Denmark, Djibouti, El Salvador, Egypt, Equatorial Guinea, Eritrea, Estonia, Ethiopia, Finland, France, French Guiana, French Polynesia, Gabon, Georgia, Germany, Ghana, Greece, Greenland, Grenada, Grenadines, Guinea, Guinea-Bissau, Hungary, Iceland, Indonesia, Iran, Iraq, Israel, Italy, Jordan, Kazakhstan, North Korea, South Korea, Kuwait, Kyrgyzstan, Laos, Latvia, Lebanon, Lesotho, Libya, Liechtenstein, Lithuania, Luxembourg, Macedonia, Madagascar, Maldives, Mali, Martinique, Mauritania, Mauritius, Moldova, Monaco, Mongolia, Montenegro, Morocco, Mozambique, Myanmar, Namibia, Nepal, Netherlands, New Caledonia, New Hebrides, Niger, Norway, Oman, Pakistan, Paraguay, Peru, Philippines, Poland, Polynesia, Portugal, Romania, Russia, Rwanda, St. Maarten, St. Pierre, St. Vincent, Samoa American, San Marino, Sao Tome & Principe, Saudi Arabia, Senegal, Serbia, Singapore, Slovakia, Slovenia, Somalia, Spain, Sri Lanka, Sudan, Suriname, Swaziland, Sweden, Switzerland, Syria, Tajikistan, Tahiti, Thailand, Tibet, Togo, Tonga, Tunisia, Turkey, Turkmenistan, Ukraine, UAE, Uzbekistan, Vanuatu, Vietnam, and Zambia.

Zone 2 may relate to an adaptor similar to that illustrated in FIG. 3. The geographic locations that utilize an adaptor similar or identical to that of FIG. 3 include, without limitation, the United States (US), Canada, Anguilla, Antigua & Barbuda, Aruba, Bahamas, Bangladesh, Barbados, Belize, Bermuda, Bolivia, Bonaire, Brazil, Cayman Islands, China, Colombia, Costa Rica, Cuba, Curacao, Dominican Republic, Ecuador, El Salvador, Faroe Islands, Falkland Islands, Guam, Guatemala, Guyana, Haiti, Honduras, Jamaica, Japan, Kiribati, North Korea, South Korea, Laos, Lebanon, Liberia, Mexico, Micronesia, Montserrat, Netherlands, Antilles, Nicaragua, Okinawa, Panama, Peru, Philippines, Puerto Rico, Samoa American, Samoa Western, Saudi Arabia, St. Pierre/Miquelon, Taiwan, Thailand, Tobago, Trinidad, Turks & Caicos Islands, Virgin Islands, Venezuela, Vietnam, and Yemen.

Zone 3 may relate to an adaptor similar to that illustrated in FIG. 4. The geographic locations that utilize an adaptor similar or identical to that of FIG. 4 include, without limitation, Australia (AU), New Zealand, Argentina, China, Cook Islands, Fiji, French Polynesia, Gilbert Islands, Indonesia, Kiribat, Nauru, New Hebrides, Norfolk, Okinawa, Panama, Papua New Guinea, Polynesia, Samoa, American Samoa, Solomon Islands, Tahiti, Tibet, Tonga, Tuvalu, Uruguay, and Vanuatu.

Zone 4 may relate to an adaptor similar to that illustrated in FIG. 5. The geographic locations that utilize an adaptor similar or identical to that of FIG. 5 include, without limitation, the United Kingdom (UK), Abu Dhabi, Antigua & Barbuda, Bahrain, Bangladesh, Belize, Bermuda, Botswana, Brunei, Burma, Channel Islands, China, Cyprus, Dominica, Falkland Islands, Gambia, Ghana, Gibraltar, Grenada, Guyana, Hong Kong, India, Iraq, Ireland, Isle of Man, Isle of Wight, Jordan, Kenya, Kuwait, Macao, Malawi, Malaysia, Maldives, Malta, Mauritius, Myanmar, New Hebrides, Nigeria, Northern Ireland, Oman, Qatar, St. Kitts & Nevis, St. Lucia, St. Vincent, Saudi Arabia, Scotland, Seychelles, Sierra Leone, Singapore, Sudan, Tanzania, Tobago, Trinidad, Uganda, UAE, Vanuatu, Wales, Yemen, Zambia, and Zimbabwe.

Although an implementation of the map has been disclosed with four zones, one skilled in the art should appreciate that the map may include correlated data collectively represented by more or less than four zones without departing from the scope of the present disclosure. This allows the map as described herein to represent various numbers of geographically specific products.

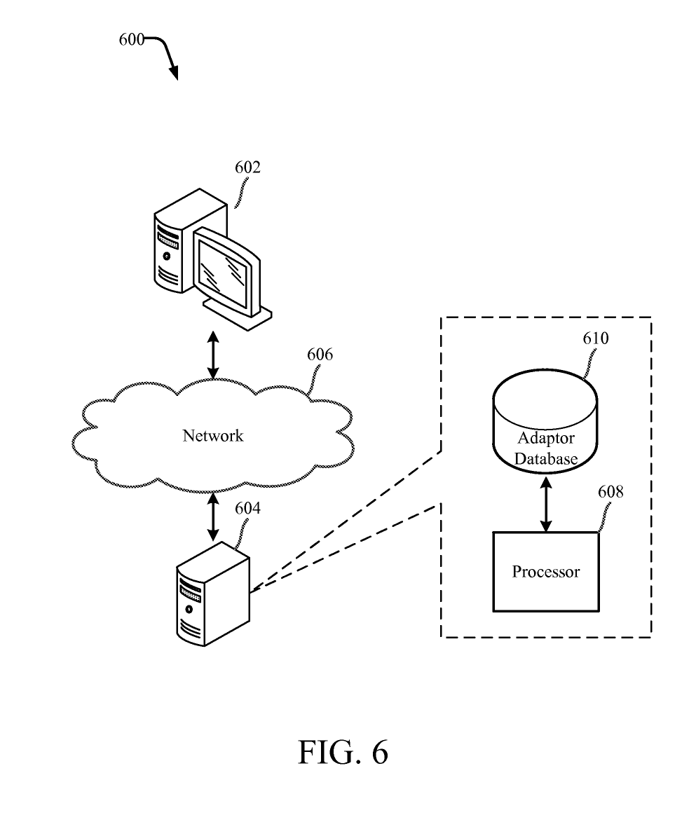

FIG. 6 illustrates a system 600 for providing a traveler with a graphic depiction, for example a map, containing geographic specific product indicia according to the present disclosure. The system 600 includes a traveler computer 602 and a map generating computer 604 in communication via one or more networks (collectively referred to and depicted as network 606).

The traveler computer 602 generates a request soliciting information specific to travel considerations. Such a request may solicit information pertaining to a product required for use within certain geographic locations. In a non-limiting example, the request may solicit the type(s) of plug adaptors used in certain geographic locations, e.g., countries, to be traveled during a trip.

The map generating computer 604 receives the request from the traveler computer 602 via the network 606. The map generating computer 604 includes a processor 608 configured to perform the functions described herein and an adaptor database 610. The adaptor database 610 contains information specific on a geographic location level. Products, such as plug adaptors, are sometimes specific to certain countries. Accordingly, in a non-limiting example, the information contained within the adaptor database 610 may be categorized on a country-by-country basis.

The processor 608 analyzes the request to determine the information being solicited. The processor 608 also accesses the adaptor database 610 to obtain information relevant to the request. The processor 608 thereby generates a depiction, e.g., a graphical map, detailing the obtained information relevant to the request. This depiction is transmitted to the traveler computer 602 via the network 606.

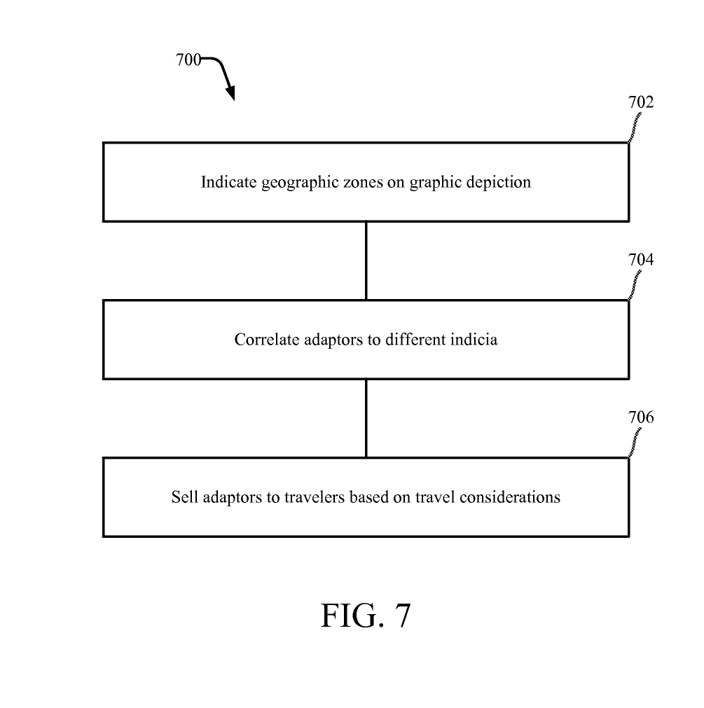

FIG. 7 illustrates a method 700 for providing a traveler with an adaptor based on travel considerations. At block 702 geographic zones are indicated on a graphic depiction. Each of the geographic zones are evidences by a different indicia. Such indicia includes, for example, shapes, text or letters, colors, patterns, or the like. The graphic depiction may be a map. When the graphic depiction is a map, the indicia may abut on the map at borders of countries. At block 704 adaptors are correlated to the different indicia. Each of the adaptors may be correlated with an indicia specific to a geographic zone that uses the adaptor. For example, when the indicia involves color coding, the adaptors may be colored corresponding to the color of the geographic zone that uses each respective adaptor. At block 706 adaptors are sold to travelers based on travel considerations. The travel considerations may include countries the travelers intend to visit.

The map generated according to the present disclosure may be correlated and provided or displayed to travelers or other product users in a static non-interactive form or, alternatively, in an interactive form. For example, the map may be implemented within a number of different devices and computer systems, including, for example, special-purpose computing systems, server-client computing systems, mainframe computing systems, a cloud computing infrastructure, telephone computing systems, laptop computers, desktop computers, smart phones, cellular phones, personal digital assistants (PDAs), tablet computers, and other mobile devices. The devices and computing systems may have one or more databases and other storage apparatuses, servers, and additional components, for example, processors, modems, terminals and displays, computer-readable media, algorithms, modules, and other computer-related components. The devices and computer systems and/or computing infrastructures are configured, programmed, and adapted to perform the functions and processes of the systems and methods as disclosed herein.

Further, communications between components in the systems and methods disclosed herein may be unidirectional or bidirectional electronic communications through a wired or wireless configuration or network. For example, one component may be wired or networked wirelessly directly or indirectly, through a third party intermediary, over the Internet, or otherwise with another component to enable communication between the components. Examples of wireless communications include, but are not limited to, radio frequency (RF), infrared, Bluetooth, wireless local area network (WLAN) (such as WiFi), or wireless network radio, such as a radio capable of communication with a wireless communication network such as a Long Term Evolution (LTE) network, WiMAX network, 3G network, 4G network, and other communication networks of the type.

Although the devices, systems, and methods have been described and illustrated in connection with certain implementations, many variations and modifications should be evident to those skilled in the art and may be made without departing from the spirit and scope of this disclosure. The present discourse is thus not to be limited to the precise details of methodology or construction set forth above as such variations and modifications are intended to be included within the scope of this disclosure.

What is claimed is:

1. A method of providing a traveler with an adaptor based on travel considerations, comprising the steps of:
indicating geographic zones on a graphic depiction, each of the geographic zones being evidenced by a different indicia;
associating adaptors to the different indicia, each adaptor being correlated with an indicia correlated with a geographic zone that uses the adaptor; and
providing the adaptors to the travelers based on travel considerations, the travel considerations including countries the travelers intend to visit.

2. The method of claim 1, wherein the graphic depiction is a map; and the adaptor provides access to an electrical receptacle.

3. The method of claim 2, wherein the different indicia abut on the map at borders of countries.

4. The method of claim 1, wherein the indicia is color coded.

5. The method of claim 4, wherein the adaptors are colored according to geographic zone indicia colors evidenced on the graphic depiction.

6. A device for providing a traveler with an adaptor based on travel considerations, comprising:
a memory including an adaptor database, the adaptor database containing plug adaptor information specific to geographic locations; and
a processor configured to execute instructions stored within the memory to perform a set of actions, the processor generating a map having geographic zones, each of the geographic zones being evidenced by a different indicia, the processor further receiving an indication from a traveler evidencing trip information, the processor correlating the received trip information with the geographic zones of the map, and the processor transmitting a suggestion for a plug adaptor to the traveler, the suggested plug adaptor being correlated to indicia of the geographic zone relevant to the received trip information.

7. The device of claim 6, wherein the indicia is color-coded.

8. The device of claim 6, wherein the trip information includes more than one country.

9. The device of claim 8, wherein the more than one country span more than one geographic zone.

10. The device of claim 8, wherein the more than one country correlate with more than one indicia.

11. The device of claim 9, wherein the processor suggests more than one plug adaptor to the traveler, each of the more than one plug adaptor correlating to a different geographic zone.

12. The device of claim 10, wherein the processor suggests a combo plug adaptor to the traveler, the combo plug adaptor being usable in countries correlated to more than one indicia.

13. A system for providing a traveler with a product based on travel considerations, comprising:
a traveler computer; and
a product computer in communication with the traveler computer, the product computer including a processor and a memory including instructions operable to be executed by the processor to perform a set of actions, the processor generating a graphic depiction having geographic zones evidenced by indicia, the processor further receiving an indication from the traveler computer evidencing trip information, the processor correlating the received trip information with the geographic zones of the graphic depiction, and the processor transmitting a suggestion for a product to the traveler computer using the indicia of the geographic zone relevant to the received trip information.

14. The system of claim 13, wherein the indication from the traveler computer evidencing trip information includes the traveler computer interacting with the graphic depiction to select at least one geographic location relevant to a trip.

15. The system of claim 14, wherein the at least one geographic location including at least one country.

16. The system of claim 13, wherein each of the geographic zones of the graphic depiction include multiple countries.

17. The system of claim 13, wherein at least one of the geographic zones of the graphic depiction includes countries from at least two different continents.

18. The system of claim 13, wherein the product is a plug adaptor.

19. The system of claim 13, wherein the suggestion includes more than one product, each of the more than one product correlating to a different geographic zone.

20. The system of claim 13, wherein the suggestion includes a combo product, the combo product being usable in geographic zones correlated to more than one indicia.
